(19) United States
(12) Patent Application Publication
(10) Pub. No.: US 2026/0271012 A1
(43) Pub. Date: Sep. 10, 2026

(54) UNIFIED TRANSMISSION CONFIGURATION INDICATOR STATE INDICATIONS IN DOWNLINK CONTROL INFORMATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/875,464

(22) PCT Filed: Aug. 26, 2022
(86) PCT No.: PCT/CN2022/115013

§ 371 Date: Dec. 16, 2024

(51) Int. Cl. H04W 72/232; H04B 7/06

(52) U.S. Cl. CPC H04W 72/232; H04B 7/06964

(57) ABSTRACT

Various aspects of the present disclosure generally relate to wireless communication. In some aspects, a mobile station may receive downlink control information (DCI) in a control resource set that is associated with an index other than zero. Accordingly, the mobile station may apply a unified transmission configuration indicator (TCI) state indicated by a TCI state indication in the DCI. Numerous other aspects are described.

### FIELD OF THE DISCLOSURE

Aspects of the present disclosure generally relate to wireless communication and to techniques and apparatuses for unified transmission configuration indicator state indications in downlink control information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a mobile station. The apparatus may include a memory and one or more processors coupled to the memory. The one or more processors, based at least in part on information stored in the memory, may be configured to receive downlink control information (DCI) in a control resource set (CORESET) that is associated with an index other than zero. The one or more processors, based at least in part on information stored in the memory, may be configured to apply a unified transmission configuration indicator (TCI) state indicated by a TCI state indication in the DCI.

Some aspects described herein relate to an apparatus for wireless communication at a network entity. The apparatus may include a memory and one or more processors coupled to the memory. The one or more processors, based at least in part on information stored in the memory, may be configured to generate DCI with a TCI state indication associated with a unified TCI state. The one or more processors, based at least in part on information stored in the memory, may be configured to transmit the DCI in a CORESET that is associated with an index other than zero.

Some aspects described herein relate to a method of wireless communication performed by a mobile station. The method may include receiving, by the mobile station, DCI in a CORESET that is associated with an index other than zero. The method may include applying, at the mobile station, a unified TCI state indicated by a TCI state indication in the DCI.

Some aspects described herein relate to a method of wireless communication performed by a network entity. The method may include generating, at the network entity, DCI with a TCI state indication associated with a unified TCI state. The method may include transmitting, by the network entity, the DCI in a CORESET that is associated with an index other than zero.

Some aspects described herein relate to a non-transitory computer-readable medium that stores a set of instructions for wireless communication by a mobile station. The set of instructions, when executed by one or more processors of the mobile station, may cause the mobile station to receive DCI in a CORESET that is associated with an index other than zero. The set of instructions, when executed by one or more processors of the mobile station, may cause the mobile station to apply a unified TCI state indicated by a TCI state indication in the DCI.

Some aspects described herein relate to a non-transitory computer-readable medium that stores a set of instructions for wireless communication by a network entity. The set of instructions, when executed by one or more processors of the network entity, may cause the network entity to generate DCI with a TCI state indication associated with a unified TCI state. The set of instructions, when executed by one or more processors of the network entity, may cause the network entity to transmit the DCI in a CORESET that is associated with an index other than zero.

Some aspects described herein relate to an apparatus for wireless communication. The apparatus may include means for receiving DCI in a CORESET that is associated with an index other than zero. The apparatus may include means for applying a unified TCI state indicated by a TCI state indication in the DCI.

Some aspects described herein relate to an apparatus for wireless communication. The apparatus may include means for generating DCI with a TCI state indication associated with a unified TCI state. The apparatus may include means for transmitting the DCI in a CORESET that is associated with an index other than zero.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of using beams for communications between a network node and a UE, in accordance with the present disclosure.

FIG. 5 is a diagram illustrating an example associated with receiving and processing downlink control information (DCI) indicating a unified transmission configuration indicator (TCI) state, in accordance with the present disclosure.

FIGS. 6 and 7 are diagrams illustrating example processes associated with processing DCI indicating a unified TCI state, in accordance with the present disclosure.

FIGS. 8 and 9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

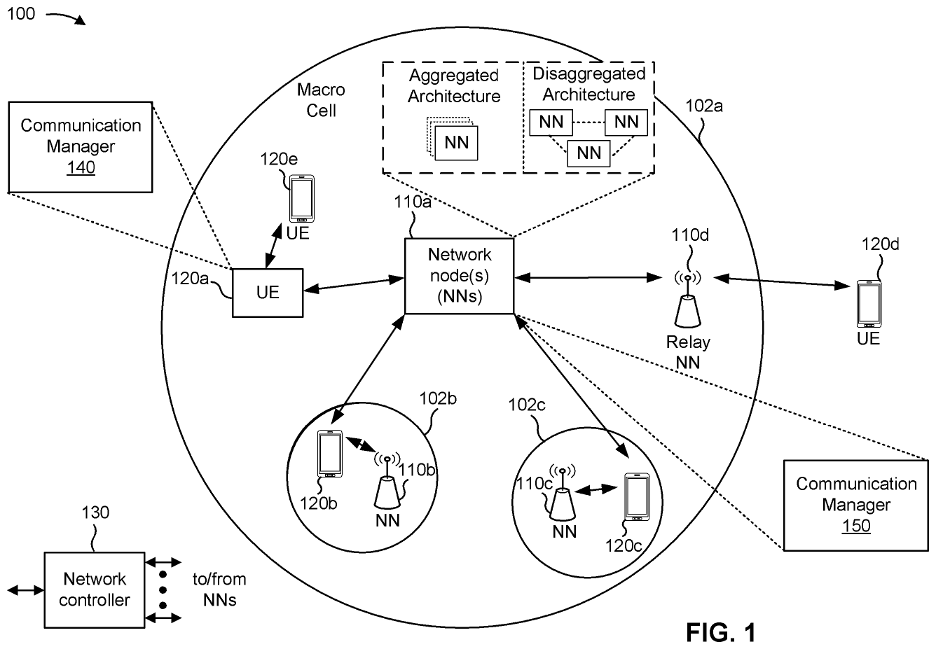

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a mobile station (e.g., the UE 120) may include a communication manager 140. As described in more detail elsewhere herein, the communication manager 140 may receive downlink control information (DCI) in a control resource set (CORESET) that is associated with an index other than zero and may apply a unified transmission configuration indicator (TCI) state indicated by a TCI state indication in the DCI. Additionally, or alternatively, the communication manager 140 may perform one or more other operations described herein.

In some aspects, a network entity (e.g., the network node 110) may include a communication manager 150. As described in more detail elsewhere herein, the communication manager 150 may generate DCI with a TCI state indication associated with a unified TCI state and may transmit the DCI in a CORESET that is associated with an index other than zero. Additionally, or alternatively, the communication manager 150 may perform one or more other operations described herein.

As indicated above, FIG. 1 is provided as an example. Other examples may differ from what is described with regard to FIG. 1.

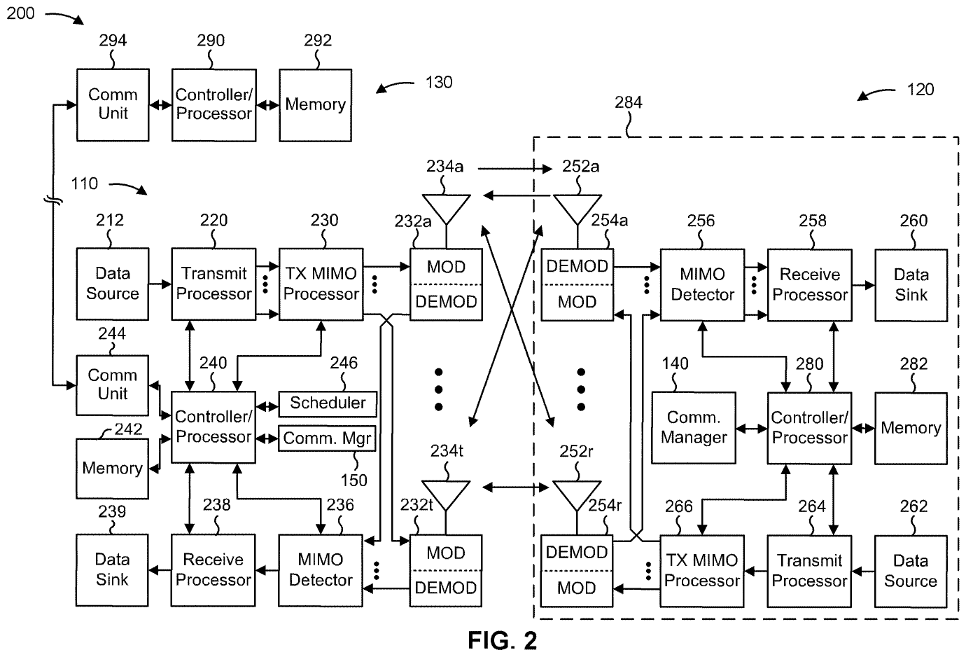

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

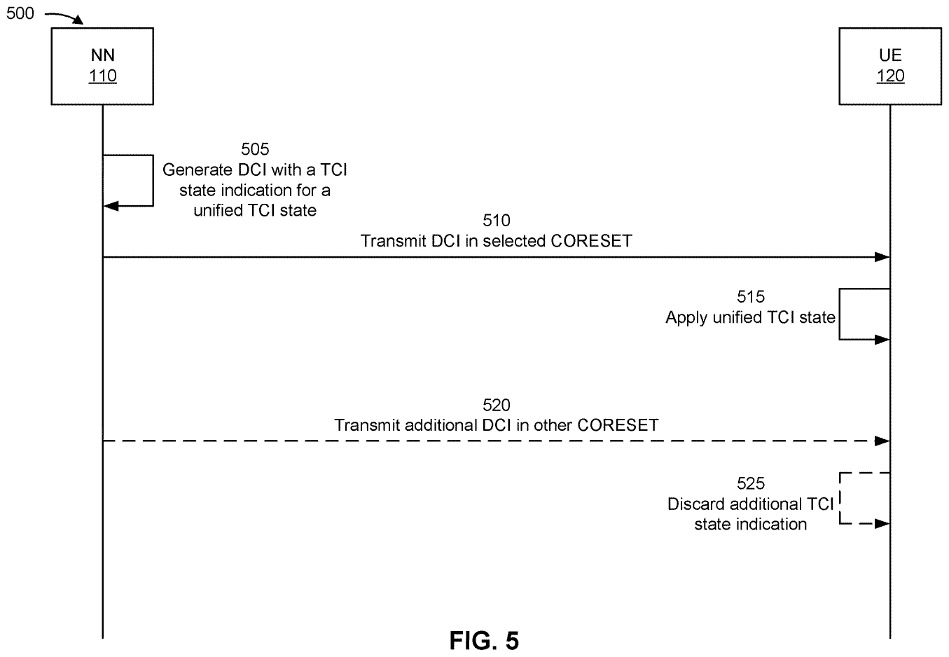

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

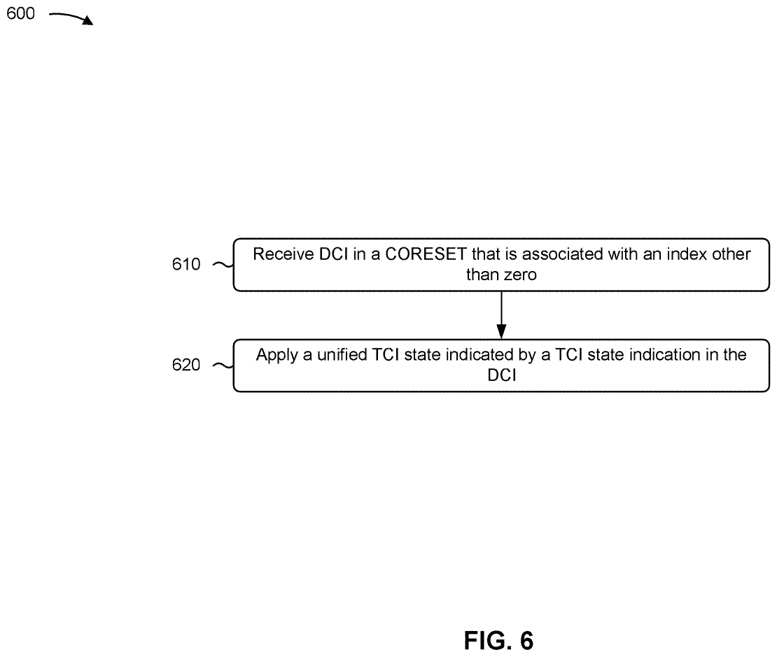

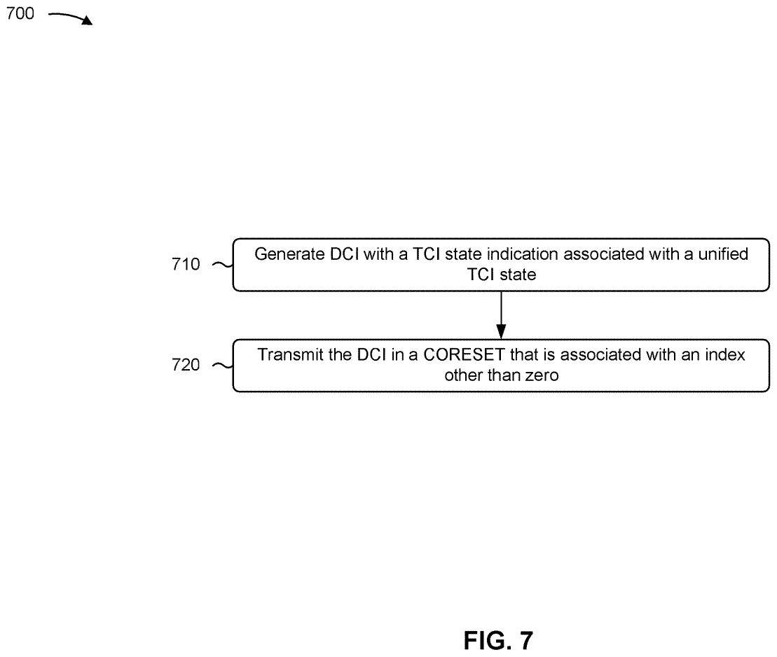

The controller/processor 240 of the network node 110, the controller/processor 280 of the UE 120, and/or any other component(s) of FIG. 2 may perform one or more techniques associated with generating and applying unified TCI state indications in DCI, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples. In some aspects, the mobile station described herein is the UE 120, is included in the UE 120, or includes one or more components of the UE 120 shown in FIG. 2.

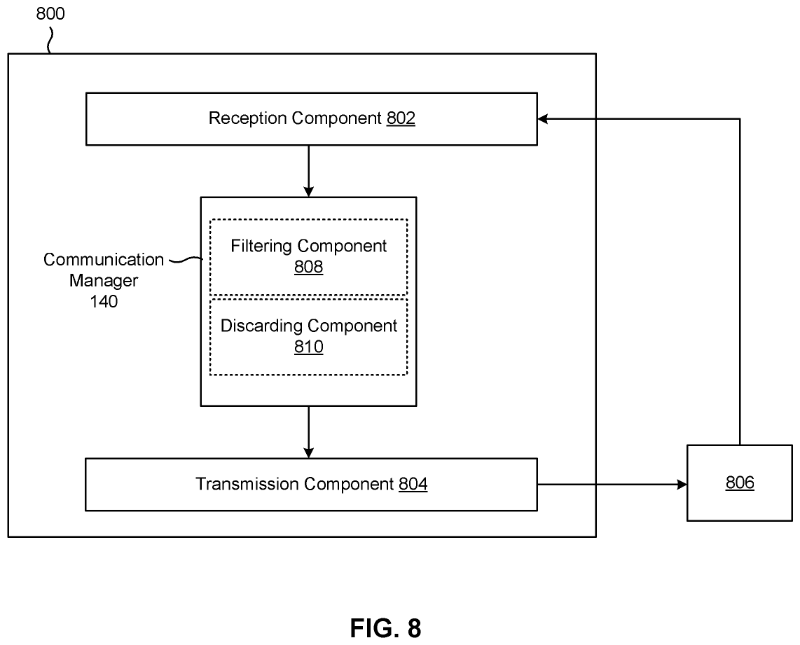

In some aspects, a mobile station (e.g., the UE 120 and/or apparatus 800 of FIG. 8) may include means for receiving DCI in a CORESET that is associated with an index other than zero and/or means for applying a unified TCI state indicated by a TCI state indication in the DCI. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

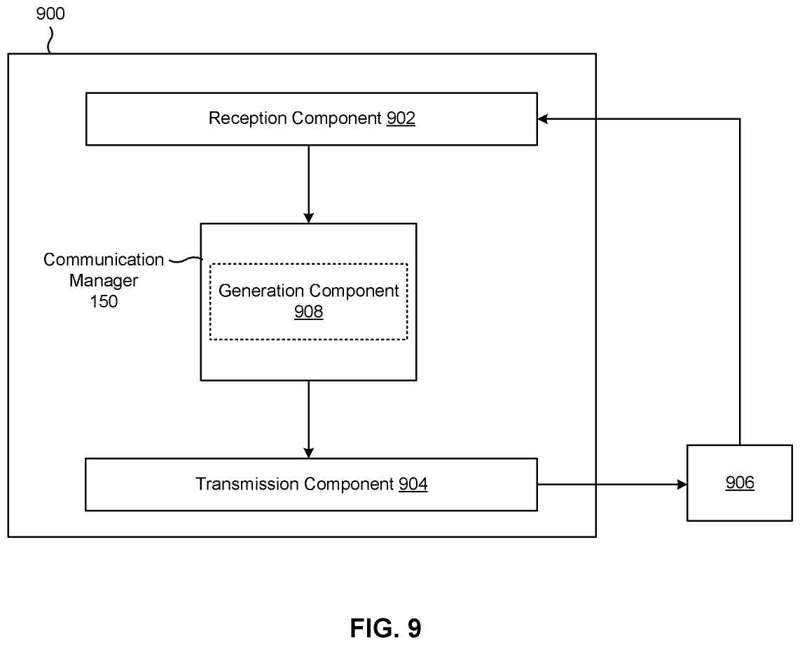

In some aspects, a network entity (e.g., the network node 110 and/or apparatus 900 of FIG. 9) may include means for generating DCI with a TCI state indication associated with a unified TCI state and/or means for transmitting the DCI in a CORESET that is associated with an index other than zero. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

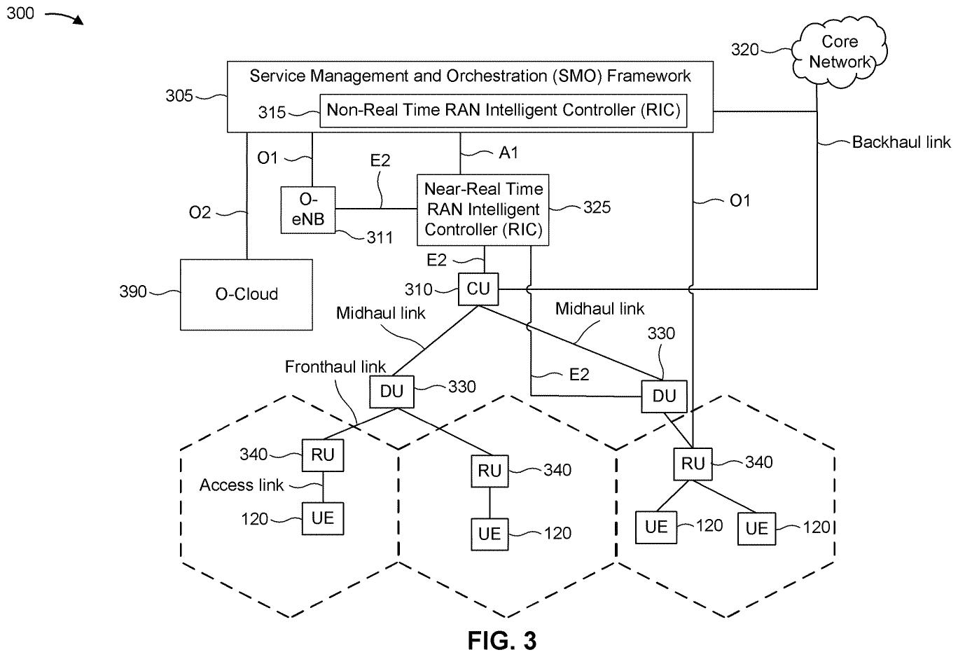

FIG. 3 is a diagram illustrating an example di saggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

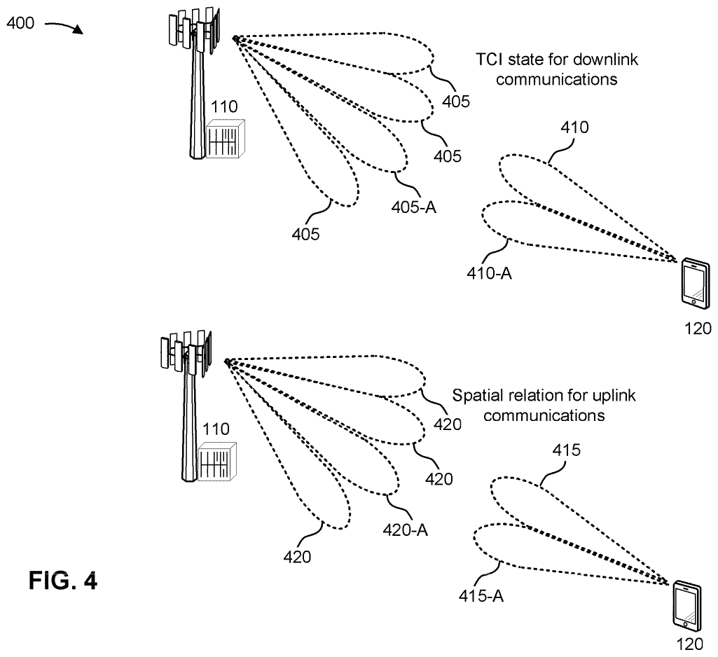

FIG. 4 is a diagram illustrating an example 400 of using beams for communications between a network node and a UE, in accordance with the present disclosure. As shown in FIG. 4, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (NN) transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 405.

The UE 120 may attempt to receive downlink transmissions via one or more UE receive beams 410, which may be configured using different beamforming parameters at receive circuitry of the UE 120. The UE 120 may identify a particular NN transmit beam 405, shown as NN transmit beam 405-A, and a particular UE receive beam 410, shown as UE receive beam 410-A, that provide relatively favorable performance (for example, that have a best channel quality of the different measured combinations of NN transmit beams 405 and UE receive beams 410). In some examples, the UE 120 may transmit an indication of which NN transmit beam 405 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 405-A and the UE receive beam 410-A), which may be further refined and maintained in accordance with one or more established beam refinement procedures.

A downlink beam, such as an NN transmit beam 405 or a UE receive beam 410, may be associated with a TCI state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each NN transmit beam 405 may be associated with a synchronization signal block (SSB), and the UE 120 may indicate a preferred NN transmit beam 405 by transmitting uplink transmissions in resources of the SSB that are associated with the preferred NN transmit beam 405. A particular SSB may have an associated TCI state (for example, for an antenna port or for beamforming). The network node 110 may, in some examples, indicate a downlink NN transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the network node 110 indicating an NN transmit beam 405 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 415.

The network node 110 may receive uplink transmissions via one or more NN receive beams 420 (e.g., BS receive beams). The network node 110 may identify a particular UE transmit beam 415, shown as UE transmit beam 415-A, and a particular NN receive beam 420, shown as NN receive beam 420-A, that provide relatively favorable performance (for example, that have a best channel quality of the different measured combinations of UE transmit beams 415 and NN receive beams 420). In some examples, the network node 110 may transmit an indication of which UE transmit beam 415 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 415-A and the NN receive beam 420-A), which may be further refined and maintained in accordance with one or more established beam refinement procedures. An uplink beam, such as a UE transmit beam 415 or an NN receive beam 420, may be associated with a spatial relation. A spatial relation may indicate a directionality or a characteristic of the uplink beam, similar to one or more QCL properties, as described above.

Additionally, or alternatively, as shown in FIG. 4, the network node 110 and the UE 120 may communicate using a unified TCI framework, in which case the network node 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a physical uplink shared channel (PUSCH) based on a dynamic grant or a configured grant or one or more dedicated physical uplink control channel (PUCCH) resources in a component carrier.

Additionally, or alternatively, the unified TCI framework may support a separate downlink (DL) TCI state and a separate uplink (UL) TCI state to accommodate separate downlink and uplink beam indications (e.g., in cases where a best uplink beam does not correspond to a best downlink beam, or vice versa). In such cases, each valid uplink TCI state configuration may contain a source reference signal to indicate an uplink transmit beam for a target uplink communication (e.g., a target uplink reference signal or a target uplink channel). For example, the source reference signal may be an sounding reference signal (SRS), an SSB, or a CSI-RS, among other examples, and the target uplink communication may be a PRACH, a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (e.g., Doppler shift, Doppler spread, average delay, or delay spread, among other examples) for uplink TCI communication.

In order to indicate a unified TCI state for a UE to apply, a network node may transmit DCI with a TCI state indication that is associated with the unified TCI state (e.g., because the TCI state indication is set to a codepoint corresponding to an index associated with the unified TCI state). Some techniques and apparatuses described herein enable a network entity (e.g., network node 110) to use rules to determine which CORESETs may be used to transmit DCI that indicates (e.g., to a UE, such as UE 120) a unified TCI state to apply. Accordingly, the UE 120 may refrain from decoding TCI state indications in DCI transmitted in some CORESETs and refrain from applying unified TCI states indicated by DCI transmitted in those CORESETs. As a result, the UE 120 conserves power and processing resources.

As indicated above, FIG. 4 is provided as an example. Other examples may differ from what is described with respect to FIG. 4.

FIG. 5 is a diagram illustrating an example 500 associated with receiving and processing DCI indicating a unified TCI state, in accordance with the present disclosure. As shown in FIG. 5, a network node 110 (e.g., an RU 340 or a device controlling the RU 340, such as a DU 330 and/or a CU 310) and a UE 120 may communicate with one another (e.g., on a wireless network, such as wireless network 100 of FIG. 1).

As shown by reference number 505, the network node 110 may generate DCI with a TCI state indication associated with a unified TCI state. For example, the DCI may be format 1_1 or format 1_2, as defined in 3GPP specifications and/or another standard. In some aspects, the DCI may include an assignment (e.g., of resources) for a downlink communication from the network node 110 to the UE 120. Alternatively, the DCI may fail to include an assignment for a downlink communication. The TCI state indication may include a field set to a codepoint that corresponds to an index associated with the unified TCI state.

As shown by reference number 510, the network node 110 may transmit (e.g., directly or via the RU 340), and the UE 120 may receive, the DCI. In some aspects, the network node 110 may select a CORESET, for transmitting the DCI, that is associated with an index other than zero. Accordingly, the network node 110 may refrain from transmitting the DCI in CORESET 0 (e.g., the CORESET associated with initial access). The CORESET 0 may be a Type-0 PDCCH common search space (CSS) set.

In some aspects, the network node 110 may select a CORESET that is a Type-3 PDCCH CSS set or a UE-specific search space (USS) set (e.g., defined by a SearchSpace data structure, as defined in 3GPP specifications and/or another standard). Alternatively, the network node 110 may select a CORESET, other than a Type-3 PDCCH CSS set or a USS set, that is associated with a follow UnifiedTCIstate parameter (e.g., as defined in 3GPP specifications and/or another standard). For example, the network node 110 may select a Type-0A PDCCH CSS (e.g., defined by a searchSpaceOther SystemInformation data structure, as defined in 3GPP specifications and/or another standard), a Type-1 PDCCH CSS (e.g., defined by an ra-SearchSpace data structure, as defined in 3GPP specifications and/or another standard), or a Type-2PDCCH CSS (e.g., defined by an pagingSearchSpace data structure, as defined in 3GPP specifications and/or another standard). The CORESET may be associated with the follow UnifiedTCIstate parameter because a data structure defining the CORESET includes at least one bit (e.g., set to ‘1’ or ‘TRUE’) representing the follow UnifiedTCIstate parameter.

Additionally, in some aspects, the network node 110 may select a CORESET that is not a beam failure recovery (BFR) CORESET. For example, the network node 110 may designate a CORESET, out of a plurality of CORESETs configured for use with the UE 120, as the BFR CORESET for the UE 120 to use during a BFR procedure.

Additionally, in some aspects, the network node 110 may scramble the DCI with a radio network temporary identifier (RNTI) other than a temporary cell RNTI (TC-RNTI). For example, the TC-RNTI may be used to scramble DCI transmitted during a random access procedure.

Therefore, as shown by reference number 515, the UE 120 may apply the unified TCI state indicated by the TCI state indication in the DCI. For example, the UE 120 may decode the TCI state indication because the DCI is received in a CORESET that is not the BFR CORESET and that is a Type-3 PDCCH CSS set, is a USS set, or is associated with the follow UnifiedTCIstate parameter. Additionally, the UE 120 may decode the TCI state indication because the DCI is not scrambled using the TC-RNTI. To apply the unified TCI state, the UE 120 may adjust properties (e.g., a transmit power, a filter scheme, or a gain threshold, among other examples) of hardware components included a receive chain and/or a transmit chain (e.g., including antennas, an analog-to-digital converter (ADC), a digital-to-analog converter (DAC), amplifiers, modulators, or demodulators, among other examples). For example, the UE 120 may apply the unified TCI state to receive communications from the network node 110 (e.g., when the unified TCI state is a DL TCI state or a joint TCI state) and/or to transmit communications to the network node 110 (e.g., when the unified TCI state is a UL TCI state or a joint TCI state).

In some aspects, as shown by reference number 520, the network node 110 may inadvertently transmit additional DCI with an additional TCI state indication associated with an additional unified TCI state in a CORESET that is not configured to carry DCI indicating unified TCI states. For example, the network node may inadvertently transmit the additional DCI in a CORESET that is the BFR CORESET or a CORESET that is not a Type-3 PDCCH CSS set, is not a USS set, and is not associated with the follow UnifiedTCIstate parameter. Additionally, or alternatively, the network node 110 may scramble the additional DCI using the TC-RNTI (e.g., during a random access procedure).

Therefore, as shown by reference number 525, the UE 120 may discard the additional TCI state indication included in the additional DCI. For example, the UE 120 may refrain from decoding a field in the additional DCI corresponding to the additional TCI state indication. Alternatively, the UE 120 may decode the field but remove decoded information corresponding to the field from a memory of the UE 120 without applying the additional unified TCI state associated with the additional TCI state indication.

By using techniques as described in connection with FIG. 5, the UE 120 may refrain from decoding TCI state indications in DCI transmitted in CORESET 0, CORESETs associated with a follow UnifiedTCIstate parameter, and the BFR CORESET, among other examples, as well as in DCI scrambled with the TC-RNTI. Moreover, the UE 120 may refrain from applying unified TCI states indicated by DCI transmitted in CORESET 0, CORESETs associated with a follow UnifiedTCIstate parameter, and the BFR CORESET, among other examples, as well as in DCI scrambled with the TC-RNTI. As a result, the UE 120 conserves power and processing resources.

In some aspects, when the UE 120 would transmit the last symbol of a PUCCH with HARQ-ACK information or a PUSCH with HARQ-ACK information corresponding to the DCI carrying the TCI state indication and without DL assignment, or corresponding to the PDSCH scheduling by the DCI carrying the TCI State indication except a DCI that is detected in a CORESET with index 0 or a CORESET associated with both a CSS set other than Type-3 PDCCH CSS set and a USS and/or a Type-3 PDCCH CSS set that is not provided with follow UnifiedTCIstate and/or a DCI that is scrambled by TC-RNTI, and if the indicated TCI State is different from the previously indicated one, the indicated DL or joint TCI (e.g., DLor JointTCIState) or UL TCI (e.g., UL-TCIstate) should be applied starting from the first slot that is at least a quantity of symbols (e.g., BeamAppTime_r17 symbols) after the last symbol of the PUCCH or the PUSCH. The first slot and the quantity of symbols are both determined on the carrier with the smallest subcarrier spacing (SCS) among the carrier(s) applying the beam indication.

As indicated above, FIG. 5 is provided as an example. Other examples may differ from what is described with respect to FIG. 5.

FIG. 6 is a diagram illustrating an example process 600 performed, for example, by a mobile station, in accordance with the present disclosure. Example process 600 is an example where the mobile station (e.g., UE 120 and/or apparatus 800 of FIG. 8) performs operations associated with processing unified TCI state indications in DCI.

As shown in FIG. 6, in some aspects, process 600 may include receiving DCI in a CORESET that is associated with an index other than zero (block 610). For example, the mobile station (e.g., using communication manager 140 and/or reception component 802, depicted in FIG. 8) may receive DCI in a CORESET that is associated with an index other than zero, as described herein.

As further shown in FIG. 6, in some aspects, process 600 may include applying a unified TCI state indicated by a TCI state indication in the DCI (block 620). For example, the mobile station (e.g., using communication manager 140 and/or filtering component 808, depicted in FIG. 8) may apply a unified TCI state indicated by a TCI state indication in the DCI, as described herein.

Process 600 may include additional aspects, such as any single aspect or any combination of aspects described below and/or in connection with one or more other processes described elsewhere herein.

In a first aspect, the CORESET is a Type-3 PDCCH CSS set or a USS set.

In a second aspect, alone or in combination with the first aspect, the CORESET is other than a Type-3 PDCCH CSS set or a USS set.

In a third aspect, alone or in combination with one or more of the first and second aspects, the CORESET is associated with a follow UnifiedTCIstate parameter.

In a fourth aspect, alone or in combination with one or more of the first through third aspects, process 600 includes receiving (e.g., using communication manager 140 and/or reception component 802) additional DCI with an additional TCI state indication associated with an additional unified TCI state, and discarding (e.g., using communication manager 140 and/or discarding component 810, depicted in FIG. 8) the additional TCI state indication based at least in part on the additional DCI being received in an additional CORESET, other than a Type-3 PDCCH CSS set or a USS set, that is not associated with the follow UnifiedTCIstate parameter.

In a fifth aspect, alone or in combination with one or more of the first through fourth aspects, the CORESET is not a BFR CORESET.

In a sixth aspect, alone or in combination with one or more of the first through fifth aspects, process 600 includes receiving (e.g., using communication manager 140 and/or reception component 802) additional DCI with an additional TCI state indication associated with an additional unified TCI state, and discarding (e.g., using communication manager 140 and/or discarding component 810) the additional TCI state indication based at least in part on the additional DCI being received in an additional CORESET that is the BFR CORESET.

In a seventh aspect, alone or in combination with one or more of the first through sixth aspects, the DCI is scrambled with an RNTI other than a TC-RNTI.

In an eighth aspect, alone or in combination with one or more of the first through seventh aspects, process 600 includes receiving (e.g., using communication manager 140 and/or reception component 802) additional DCI with an additional TCI state indication associated with an additional unified TCI state, and discarding (e.g., using communication manager 140 and/or discarding component 810) the additional TCI state indication based at least in part on the additional DCI being scrambled with a TC-RNTI.

In a ninth aspect, alone or in combination with one or more of the first through eighth aspects, process 600 includes receiving (e.g., using communication manager 140 and/or reception component 802) additional DCI with an additional TCI state indication associated with an additional unified TCI state, and discarding (e.g., using communication manager 140 and/or discarding component 810) the additional TCI state indication based at least in part on the additional DCI being received in an additional CORESET that is associated with an index of zero.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network entity, in accordance with the present disclosure. Example process 700 is an example where the network entity (e.g., network node 110 and/or apparatus 900 of FIG. 9) performs operations associated with transmitting unified TCI state indications in DCI.

As shown in FIG. 7, in some aspects, process 700 may include generating DCI with a TCI state indication associated with a unified TCI state (block 710). For example, the network entity (e.g., using communication manager 150 and/or generation component 908, depicted in FIG. 9) may generate DCI with a TCI state indication associated with a unified TCI state, as described herein.

As further shown in FIG. 7, in some aspects, process 700 may include transmitting the DCI in a CORESET that is associated with an index other than zero (block 720). For example, the network entity (e.g., using communication manager 150 and/or transmission component 904, depicted in FIG. 9) may transmit the DCI in a CORESET that is associated with an index other than zero, as described herein.

Process 700 may include additional aspects, such as any single aspect or any combination of aspects described below and/or in connection with one or more other processes described elsewhere herein.

In a first aspect, the CORESET is a Type-3 PDCCH CSS set or a USS set.

In a second aspect, alone or in combination with the first aspect, the CORESET is other than a Type-3 PDCCH CSS set or a USS set.

In a third aspect, alone or in combination with one or more of the first and second aspects, the CORESET is associated with a follow UnifiedTCIstate parameter.

In a fourth aspect, alone or in combination with one or more of the first through third aspects, process 700 includes refraining from encoding (e.g., using communication manager 150 and/or generation component 908) an additional TCI state indication, associated with an additional unified TCI state, in additional DCI, and transmitting (e.g., using communication manager 150 and/or transmission component 904) the additional DCI in an additional CORESET, other than a Type-3 PDCCH CSS set or a USS set, that is not associated with the follow UnifiedTCIstate parameter.

In a fifth aspect, alone or in combination with one or more of the first through fourth aspects, the CORESET is not a BFR CORESET.

In a sixth aspect, alone or in combination with one or more of the first through fifth aspects, process 700 includes refraining from encoding (e.g., using communication manager 150 and/or generation component 908) an additional TCI state indication, associated with an additional unified TCI state, in additional DCI, and transmitting (e.g., using communication manager 150 and/or transmission component 904) the additional DCI in an additional CORESET that is the BFR CORESET.

In a seventh aspect, alone or in combination with one or more of the first through sixth aspects, the DCI is scrambled with an RNTI other than a TC-RNTI.

In an eighth aspect, alone or in combination with one or more of the first through seventh aspects, process 700 includes refraining from encoding (e.g., using communication manager 150 and/or generation component 908) an additional TCI state indication, associated with an additional unified TCI state, in additional DCI, and transmitting (e.g., using communication manager 150 and/or transmission component 904) the additional DCI scrambled with a TC-RNTI.

In a ninth aspect, alone or in combination with one or more of the first through eighth aspects, process 700 includes refraining from encoding (e.g., using communication manager 150 and/or generation component 908) an additional TCI state indication, associated with an additional unified TCI state, in additional DCI, and transmitting (e.g., using communication manager 150 and/or transmission component 904) the additional DCI in an additional CORESET that is associated with an index of zero.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a mobile station, or a mobile station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, an RU, or another wireless communication device) using the reception component 802 and the transmission component 804. As further shown, the apparatus 800 may include the communication manager 140. The communication manager 140 may include one or more of a filtering component 808 and/or a discarding component 810, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

In some aspects, the reception component 802 may receive (e.g., from the apparatus 806, such as a network entity) DCI in a CORESET that is associated with an index other than zero. Accordingly, the filtering component 808 may apply a unified TCI state indicated by a TCI state indication in the DCI. The filtering component 808 may include one or more antennas, a modem, a demodulator, a modulator, a transmit MIMO processor, a MIMO detector, a receive processor, a transmit processor, a controller/processor, a memory, or a combination thereof, of the UE described in connection with FIG. 2.

In some aspects, the reception component 802 may receive (e.g., from the apparatus 806) additional DCI with an additional TCI state indication associated with an additional unified TCI state. Accordingly, the discarding component 810 may discard the additional TCI state indication based at least in part on the additional DCI being received in an additional CORESET, other than a Type-3 PDCCH CSS set or a USS set, that is not associated with a follow UnifiedTCIstate parameter. The discarding component 810 may include a MIMO detector, a receive processor, a controller/processor, a memory, or a combination thereof, of the UE described in connection with FIG. 2.

Alternatively, the discarding component 810 may discard the additional TCI state indication based at least in part on the additional DCI being received in an additional CORESET that is a BFR CORESET. Alternatively, the discarding component 810 may discard the additional TCI state indication based at least in part on the additional DCI being scrambled with a TC-RNTI. Alternatively, the discarding component 810 may discard the additional TCI state indication based at least in part on the additional DCI being received in an additional CORESET that is associated with an index of zero.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network entity, or a network entity may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, an RU, or another wireless communication device) using the reception component 902 and the transmission component 904. As further shown, the apparatus 900 may include the communication manager 150. The communication manager 150 may include a generation component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

In some aspects, the generation component 908 may generate DCI with a TCI state indication associated with a unified TCI state. The generation component 908 may include a transmit MIMO processor, a transmit processor, a controller/processor, a memory, or a combination thereof, of the network node described in connection with FIG. 2. Accordingly, the transmission component 904 may transmit (e.g., to the apparatus 906, such as a UE) the DCI in a CORESET that is associated with an index other than zero.

In some aspects, the generation component 908 may refrain from encoding an additional TCI state indication, associated with an additional unified TCI state, in additional DCI. Accordingly, the transmission component 904 may transmit (e.g., to the apparatus 906) the additional DCI in an additional CORESET, other than a Type-3 PDCCH CSS set or a USS set, that is not associated with a follow UnifiedTCIstate parameter.

Alternatively, the transmission component 904 may transmit the additional DCI in an additional CORESET that is a BFR CORESET. Alternatively, the transmission component 904 may transmit the additional DCI scrambled with a TC-RNTI. Alternatively, the transmission component 904 may transmit the additional DCI in an additional CORESET that is associated with an index of zero.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a mobile station, comprising: receiving, by the mobile station, downlink control information (DCI) in a control resource set (CORESET) that is associated with an index other than zero; and applying, at the mobile station, a unified transmission configuration indicator (TCI) state indicated by a TCI state indication in the DCI.

Aspect 2: The method of Aspect 1, wherein the CORESET is a Type-3 physical downlink control channel (PDCCH) common search space (CSS) set or a user equipment specific search space (USS) set.

Aspect 3: The method of Aspect 1, wherein the CORESET is other than a Type-3 physical downlink control channel (PDCCH) common search space (CSS) set or a user equipment specific search space (USS) set.

Aspect 4: The method of Aspect 3, wherein the CORESET is associated with a follow UnifiedTCIstate parameter.

Aspect 5: The method of Aspect 4, further comprising: receiving, by the mobile station, additional DCI with an additional TCI state indication associated with an additional unified TCI state; and discarding the additional TCI state indication based at least in part on the additional DCI being received in an additional CORESET, other than a Type-3 PDCCH CSS set or a USS set, that is not associated with the follow UnifiedTCIstate parameter.

Aspect 6: The method of any of Aspects 1 through 5, wherein the CORESET is not a beam failure recovery (BFR) CORESET.

Aspect 7: The method of Aspect 6, further comprising: receiving, by the mobile station, additional DCI with an additional TCI state indication associated with an additional unified TCI state; and discarding the additional TCI state indication based at least in part on the additional DCI being received in an additional CORESET that is the BFR CORESET.

Aspect 8: The method of any of Aspects 1 through 7, wherein the DCI is scrambled with a radio network temporary identifier (RNTI) other than a temporary cell RNTI (TC-RNTI).

Aspect 9: The method of Aspect 8, further comprising: receiving, by the mobile station, additional DCI with an additional TCI state indication associated with an additional unified TCI state; and discarding the additional TCI state indication based at least in part on the additional DCI being scrambled with a TC-RNTI.

Aspect 10: The method of any of Aspects 1 through 9, further comprising: receiving, by the mobile station, additional DCI with an additional TCI state indication associated with an additional unified TCI state; and discarding the additional TCI state indication based at least in part on the additional DCI being received in an additional CORESET that is associated with an index of zero.

Aspect 11: A method of wireless communication performed by a network entity, comprising: generating, at the network entity, downlink control information (DCI) with a transmission configuration indicator (TCI) state indication associated with a unified TCI state; and transmitting, by the network entity, the DCI in a control resource set (CORESET) that is associated with an index other than zero.

Aspect 12: The method of Aspect 11, wherein the CORESET is a Type-3 physical downlink control channel (PDCCH) common search space (CSS) set or a user equipment specific search space (USS) set.

Aspect 13: The method of Aspect 11, wherein the CORESET is other than a Type-3 physical downlink control channel (PDCCH) common search space (CSS) set or a user equipment specific search space (USS) set.

Aspect 14: The method of Aspect 13, wherein the CORESET is associated with a follow UnifiedTCIstate parameter.

Aspect 15: The method of Aspect 14, further comprising: refraining from encoding an additional TCI state indication, associated with an additional unified TCI state, in additional DCI; and transmitting, by the network entity, the additional DCI in an additional CORESET, other than a Type-3 PDCCH CSS set or a USS set, that is not associated with the follow UnifiedTCIstate parameter.

Aspect 16: The method of any of Aspects 11 through 15, wherein the CORESET is not a beam failure recovery (BFR) CORESET.

Aspect 17: The method of Aspect 16, further comprising: refraining from encoding an additional TCI state indication, associated with an additional unified TCI state, in additional DCI; and transmitting, by the network entity, the additional DCI in an additional CORESET that is the BFR CORESET.

Aspect 18: The method of any of Aspects 11 through 17, wherein the DCI is scrambled with a radio network temporary identifier (RNTI) other than a temporary cell RNTI (TC-RNTI).

Aspect 19: The method of Aspect 18, further comprising: refraining from encoding an additional TCI state indication, associated with an additional unified TCI state, in additional DCI; and transmitting, by the network entity, the additional DCI scrambled with a TC-RNTI.

Aspect 20: The method of any of Aspects 11 through 19, further comprising: refraining from encoding an additional TCI state indication, associated with an additional unified TCI state, in additional DCI; and transmitting, by the network entity, the additional DCI in an additional CORESET that is associated with an index of zero.

Aspect 21: An apparatus for wireless communication at a device, comprising a processor; memory coupled with the processor; and instructions stored in the memory and executable by the processor to cause the apparatus to perform the method of one or more of Aspects 1-10.

Aspect 22: A device for wireless communication, comprising a memory and one or more processors coupled to the memory, the one or more processors configured to perform the method of one or more of Aspects 1-10.

Aspect 23: An apparatus for wireless communication, comprising at least one means for performing the method of one or more of Aspects 1-10.

Aspect 24: A non-transitory computer-readable medium storing code for wireless communication, the code comprising instructions executable by a processor to perform the method of one or more of Aspects 1-10.

Aspect 25: A non-transitory computer-readable medium storing a set of instructions for wireless communication, the set of instructions comprising one or more instructions that, when executed by one or more processors of a device, cause the device to perform the method of one or more of Aspects 1-10.

Aspect 26: An apparatus for wireless communication at a device, comprising a processor; memory coupled with the processor; and instructions stored in the memory and executable by the processor to cause the apparatus to perform the method of one or more of Aspects 11-20.

Aspect 27: A device for wireless communication, comprising a memory and one or more processors coupled to the memory, the one or more processors configured to perform the method of one or more of Aspects 11-20.

Aspect 28: An apparatus for wireless communication, comprising at least one means for performing the method of one or more of Aspects 11-20.

Aspect 29: A non-transitory computer-readable medium storing code for wireless communication, the code comprising instructions executable by a processor to perform the method of one or more of Aspects 11-20.

Aspect 30: A non-transitory computer-readable medium storing a set of instructions for wireless communication, the set of instructions comprising one or more instructions that, when executed by one or more processors of a device, cause the device to perform the method of one or more of Aspects 11-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a mobile station, comprising:
a memory; and
one or more processors, coupled to the memory and based at least in part on information stored in the memory, configured to:
receive downlink control information (DCI) in a control resource set (CORESET) that is associated with an index other than zero; and
apply a unified transmission configuration indicator (TCI) state indicated by a TCI state indication in the DCI.

2. The apparatus of claim 1, wherein the CORESET is a Type-3 physical downlink control channel (PDCCH) common search space (CSS) set or a user equipment specific search space (USS) set.

3. The apparatus of claim 1, wherein the CORESET is other than a Type-3 physical downlink control channel (PDCCH) common search space (CSS) set or a user equipment specific search space (USS) set.

4. The apparatus of claim 3, wherein the CORESET is associated with a follow UnifiedTCIstate parameter.

5. The apparatus of claim 4, wherein the one or more processors are further configured to:
receive additional DCI with an additional TCI state indication associated with an additional unified TCI state; and
discard the additional TCI state indication based at least in part on the additional DCI being received in an additional CORESET, other than a Type-3 PDCCH CSS set or a USS set, that is not associated with the follow UnifiedTCIstate parameter.

6. The apparatus of claim 1, wherein the CORESET is not a beam failure recovery (BFR) CORESET.

7. The apparatus of claim 6, wherein the one or more processors are further configured to:
receive additional DCI with an additional TCI state indication associated with an additional unified TCI state; and
discard the additional TCI state indication based at least in part on the additional DCI being received in an additional CORESET that is the BFR CORESET.

8. The apparatus of claim 1, wherein the DCI is scrambled with a radio network temporary identifier (RNTI) other than a temporary cell RNTI (TC-RNTI).

9. The apparatus of claim 8, wherein the one or more processors are further configured to:
receive additional DCI with an additional TCI state indication associated with an additional unified TCI state; and
discard the additional TCI state indication based at least in part on the additional DCI being scrambled with a TC-RNTI.

10. The apparatus of claim 1, wherein the one or more processors are further configured to:
receive additional DCI with an additional TCI state indication associated with an additional unified TCI state; and
discard the additional TCI state indication based at least in part on the additional DCI being received in an additional CORESET that is associated with an index of zero.

11. An apparatus for wireless communication at a network entity, comprising:
a memory; and
one or more processors, coupled to the memory and based at least in part on information stored in the memory, configured to:
generate downlink control information (DCI) with a transmission configuration indicator (TCI) state indication associated with a unified TCI state; and
transmit the DCI in a control resource set (CORESET) that is associated with an index other than zero.

12. The apparatus of claim 11, wherein the CORESET is a Type-3 physical downlink control channel (PDCCH) common search space (CSS) set or a user equipment specific search space (USS) set.

13. The apparatus of claim 11, wherein the CORESET is other than a Type-3 physical downlink control channel (PDCCH) common search space (CSS) set or a user equipment specific search space (USS) set.

14. The apparatus of claim 13, wherein the CORESET is associated with a follow UnifiedTCIstate parameter.

15. The apparatus of claim 14, wherein the one or more processors are further configured to:
refrain from encoding an additional TCI state indication, associated with an additional unified TCI state, in additional DCI; and
transmit the additional DCI in an additional CORESET, other than a Type-3 PDCCH CSS set or a USS set, that is not associated with the follow UnifiedTCIstate parameter.

16. The apparatus of claim 11, wherein the CORESET is not a beam failure recovery (BFR) CORESET.

17. The apparatus of claim 16, wherein the one or more processors are further configured to:
refrain from encoding an additional TCI state indication, associated with an additional unified TCI state, in additional DCI; and
transmit the additional DCI in an additional CORESET that is the BFR CORESET.

18. The apparatus of claim 11, wherein the DCI is scrambled with a radio network temporary identifier (RNTI) other than a temporary cell RNTI (TC-RNTI).

19. The apparatus of claim 18, wherein the one or more processors are further configured to:
refrain from encoding an additional TCI state indication, associated with an additional unified TCI state, in additional DCI; and
transmit the additional DCI scrambled with a TC-RNTI.

20. The apparatus of claim 11, wherein the one or more processors are further configured to:
refrain from encoding an additional TCI state indication, associated with an additional unified TCI state, in additional DCI; and
transmit the additional DCI in an additional CORESET that is associated with an index of zero.

21. A method of wireless communication performed by a mobile station, comprising:
receiving, by the mobile station, downlink control information (DCI) in a control resource set (CORESET) that is associated with an index other than zero; and
applying, at the mobile station, a unified transmission configuration indicator (TCI) state indicated by a TCI state indication in the DCI.

22. The method of claim 21, wherein the CORESET is a Type-3 physical downlink control channel (PDCCH) common search space (CSS) set or a user equipment specific search space (USS) set.

23. The method of claim 21, wherein the CORESET is other than a Type-3 physical downlink control channel (PDCCH) common search space (CSS) set or a user equipment specific search space (USS) set.

24. The method of claim 23, wherein the CORESET is associated with a follow UnifiedTCIstate parameter.

25. The method of claim 24, further comprising:
receiving, by the mobile station, additional DCI with an additional TCI state indication associated with an additional unified TCI state; and
discarding the additional TCI state indication based at least in part on the additional DCI being received in an additional CORESET, other than a Type-3 PDCCH CSS set or a USS set, that is not associated with the follow UnifiedTCIstate parameter.

26. The method of claim 21, wherein the CORESET is not a beam failure recovery (BFR) CORESET.

27. The method of claim 26, further comprising:
receiving, by the mobile station, additional DCI with an additional TCI state indication associated with an additional unified TCI state; and
discarding the additional TCI state indication based at least in part on the additional DCI being received in an additional CORESET that is the BFR CORESET.

28. The method of claim 21, wherein the DCI is scrambled with a radio network temporary identifier (RNTI) other than a temporary cell RNTI (TC-RNTI).

29. The method of claim 28, further comprising:
receiving, by the mobile station, additional DCI with an additional TCI state indication associated with an additional unified TCI state; and
discarding the additional TCI state indication based at least in part on the additional DCI being scrambled with a TC-RNTI.

30. The method of claim 21, further comprising:
receiving, by the mobile station, additional DCI with an additional TCI state indication associated with an additional unified TCI state; and
discarding the additional TCI state indication based at least in part on the additional DCI being received in an additional CORESET that is associated with an index of zero.

31. A method of wireless communication performed by a network entity, comprising:
generating, at the network entity, downlink control information (DCI) with a transmission configuration indicator (TCI) state indication associated with a unified TCI state; and
transmitting, by the network entity, the DCI in a control resource set (CORESET) that is associated with an index other than zero.
